(19) United States
(12) Patent Application Publication
(10) Pub. No.: US 2025/0148361 A1
(43) Pub. Date: May 8, 2025

(54) DETERMINING GENERALIZATION OF BEHAVIOR-CLONED POLICIES

(71) Applicant: TOYOTA RESEARCH INSTITUTE, INC., LOS ALTOS, CA (US)

(72) Inventors: JOSEPH A. VINCENT, Menlo Park, CA (US); HARUKI NISHIMURA, Sunnyvale, CA (US); MIKHAL ITKINA, Stanford, CA (US); THOMAS F. KOLLAR, San Jose, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/627,189

(22) Filed: Apr. 4, 2024

Related U.S. Application Data
(60) Provisional application No. 63/596,095, filed on Nov. 3, 2023.

(51) Int. Cl. G06N 20/00

(52) U.S. Cl. CPC G06N 20/00

(57) ABSTRACT

Systems and methods are provided for assessing generalizations of machine learning models implemented in new environments, such as those not included in training data used to train the machine learning models. Examples include, after training the machine learning model on a set of training data, implementing the trained machine learning model a number of times in a new environment. For each implementation of the trained machine learning model in the new environment, a performance metric associated with performance of the machine learning model in the new environment can be measured and a confidence interval on a success rate of the machine learning model in the new environment can be determined based on the performance metric. The machine learning model can then be deployed on machines in the new environment based on the confidence interval.

### CROSS-REFERENCES TO RELATED APPLICATIONS

This application claims the benefit of and priority to U.S. Provisional Application No. 63/596,095, filed on Nov. 3, 2023, the contents of which is incorporated herein by reference in its entirety.

### TECHNICAL FIELD

The present disclosure relates generally to machine learning, and, more particularly, some embodiments relate to assessing generalizations of behavior-cloned policies implemented in new environments, which were not encountered during training of the machine learning model.

### DESCRIPTION OF RELATED ART

Machine learning may be used to train a model, based on a finite set of examples (known as training data), that generalizes beyond the examples of the training data to unseen inputs. As such, it may be desirable to determine how well a model generalizes to new inputs.

### BRIEF SUMMARY OF THE DISCLOSURE

According to various embodiments of the disclosed technology, systems and methods for assessing generalizations of behavior-cloned policies implemented in new environments, which were not encountered during training of the machine learning model, are provided.

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

In one general aspect, a method may include training a machine learning model based on a set of training data. Method may also include implementing the trained machine learning model a number of times in a new environment, where the new environment is not part of the training data. Method may furthermore include for each implementation of the trained machine learning model in the new environment, measuring a performance metric associated with performance of the machine learning model in the new environment. Method may in addition include determining a confidence interval on a success rate of the machine learning model in the new environment based on the performance metric. Method may moreover include deploying the machine learning model on machines in the new environment based on the confidence interval. Other embodiments of this aspect include corresponding computer systems, apparatus, and computer programs recorded on one or more computer storage devices, each configured to perform the actions of the methods.

Implementations may include one or more of the following features. A method where the training data is based on implementing the trained machine learning model in one or more environments that are different from the new environment. Method where implementing the training trained machine learning model may include: deploying the trained machine learning model on a machine in the new environment. Method where the performance metric may include one of: (i) a binary success or failure of each implementation of the trained machine learning model in the new environment and (ii) a continuous total reward of each implementation of the trained machine learning model in the new environment. The method may include: determining a confidence set based on the confidence interval, where the confidence set may include a confidence value representative of an acceptable lower limit of the confidence interval and at least one of: a coverage of the confidence interval, a tightness of the confidence interval to the success rate, and a minimum number of times the trained machine learning model to implement the machine learning model. The method where deploying the machine learning model on machines in the new environment based on the confidence interval may include: determining a lower limit of the confidence interval; determining if the lower limit of the confidence interval exceeds a threshold; and deploying the machine learning model on machines in the new environment when the lower limit of the confidence interval exceeds or is equal to the threshold. The method further may include: retraining the machine learning model when the lower limit of the confidence interval is below the threshold. Method may include: determining a plurality of confidence intervals for the new environment based on implementing a plurality of machine learning models in the new environment; determining an optimal confidence interval from the plurality of confidence intervals; and deploying, on machines in the new environment, a machine learning model of the plurality of machine learning models corresponding to the optimal confidence interval. Method may include: receiving an input of one or more of: (i) a confidence value representative of an acceptable lower limit of the confidence interval on a success rate of the machine learning model in the new environment and (ii) tightness of the lower limit of the confidence interval to the success rate; and computing a minimum number of implementations of the of the trained machine learning model in the new environment based on the input and a cumulative distribution function of the performance metric, where the minimum number of implementations is a number of implementations needed to achieve the input based on the performance metric, where the determined confidence interval may include the input and the minimum number of implementations of the of the trained machine learning model in the new environment. Method where the machines are may include vehicles. A system where the training data is based on implementing the trained machine learning model in one or more environments that are different from the new environment. A system where implementing the trained training machine learning model may include: deploying the trained machine learning model on a machine in the new environment. System where the performance metric may include one of: (i) a binary success or failure of each implementation of the trained machine learning model in the new environment and (ii) a continuous total reward of each implementation of the trained machine learning model in the new environment. The system may include: determining a confidence set based on the confidence interval, where the confidence set may include a confidence value representative of an acceptable lower limit of the confidence interval and at least one of: a coverage of the confidence interval, a tightness of the confidence interval to the success rate, and a minimum number of times to implement the trained machine learning model. System where deploying the machine learning model on machines in the new environment based on the confidence interval may include: determine a lower limit of the confidence interval; determine if the lower limit of the confidence interval exceeds a threshold; and deploy the machine learning model on machines in the new environment when the lower limit of the confidence interval exceeds or is equal to the threshold. System where the at least one process processor is further configured to execute the instructions to: retrain the machine learning model when the lower limit of the confidence interval is below the threshold. System where the at least one processor process is further configured to execute the instructions to: determine a plurality of confidence intervals for the new environment based on implementing a plurality of machine learning models in the new environment; determine an optimal confidence interval from the plurality of confidence intervals; and deploy, on machines in the new environment, a machine learning model of the plurality of machine learning models corresponding to the optimal confidence interval. System where the at least one processor process is further configured execute the instructions to: receive an input of one or more of: (i) a confidence value representative of an acceptable lower limit of the confidence interval on a success rate of the machine learning model in the new environment and (ii) tightness of the confidence interval to the success rate; and compute a minimum number of implementations of the of the trained machine learning model in the new environment based on the input and a cumulative distribution function of the performance metric, where the minimum number of implementations is a number of implementations needed to achieve the input based on the performance metric, where the determined confidence interval may include the input and the minimum number of implementations of the of the trained machine learning model in the new environment. System where the machines are may include vehicles. Implementations of the described techniques may include hardware, a method or process, or a computer tangible medium.

In one general aspect, system may include a memory configured to store instructions. System may also include at least one processor communicatively coupled to the memory and configured to execute the instructions to: obtain a machine learning model trained on a set of training data; implement the trained machine learning model a number of times in a new environment, where the new environment is not part of the training data; for each implementation of the trained machine learning model in the new environment, measure a performance metric associated with performance of the machine learning model in the new environment; determine a confidence interval on a success rate of the machine learning model in the new environment based on the performance metric; and deploy the machine learning model on machines in the new environment based on the confidence interval. Other embodiments of this aspect include corresponding computer systems, apparatus, and computer programs recorded on one or more computer storage devices, each configured to perform the actions of the methods.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an illustrative representation of a computer system for implementing behavior cloning models, in accordance with one or more embodiments of the disclosure.

FIG. 2 is an illustrative process flow for implementing assessment of the performance of a trained machine learning model, in accordance with one or more embodiments of the disclosure.

FIG. 3 provides example operations that may be carried out in connection with the computer implemented method, according to one or more embodiments of the present disclosure.

FIG. 4 illustrates an example architecture for a behavior cloning system in accordance with one embodiment of the systems and methods described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Embodiments of the present disclosure provide for a framework that assess generalizations of behavior-cloned policies implemented in one or more new environments. In various embodiments, a trained machine learning (ML) model can be implemented in one or more new environments that were not part of training, and a performance metric can be evaluated to assess the performance of the ML model in the new environments. In some embodiments, a confidence interval for a probability on a success rate of the ML model in the new environments (also referred to herein as performance in the new environments) can be returned with statistical guarantees based on the performance metrics. Statistical guarantees, as used herein, refers to providing a confidence on performance (e.g., true success rate) that holds with specified probability. The specified probability, in various embodiments, may be defined by a user. A determination can be made as to whether the confidence interval exceeds or is equal to a threshold. In some embodiments, the model may be deployed on machines in new environments in which the confidence interval exceeds a threshold. In another example, the ML model may be retrained when the confidence interval is below a threshold. In yet another example, multiple ML models may be compared using confidence intervals on success rates for each ML model and the ML model having an optimal confidence interval may be selected, from the multiple ML models, for deployment on machines in the new environment. In some examples, an ML model may be selected for deployment based on comparing a lower limit of the confidence interval on the success rate of one ML model with an upper limit of the confidence interval on a success rate of another. In this case, the one ML model may be selected for deployment for which the lower limit of the confidence interval is greater than or equal to the upper limit of the confidence interval of the other. That is, for example, if the upper limit of the confidence interval of the other ML model is less than the lower limit of the confidence interval of the one ML model, the one ML model may be considered as outperforming the other ML model and thus preferential for deployment.

Generally, a goal of ML is to collect a finite set of examples (e.g., training data) that can be applied to an ML algorithm, which generates an ML model that generalizes to unseen inputs beyond the training set. Generalization can be tied to performance. An ML model can be said to generalize to an environment if it performs well on unseen inputs from the environment. Performance in an environment can be bounded in terms of performance measured on an independent and identically distributed (i.i.d.) sample from that environment. Further, generalization beyond the training environment has been of interest, particular in the field of robot (or other autonomous systems) learning from demonstrations. For example, a roboticist often does not have the resources to obtain training data of demonstrations from every environment they would like the robot to operate in. One may expect a learned model to generalize to environments which are closely related but still distinct from the training environment. At the same time, trained models can be brittle when deployed in new environments. Thus, although a roboticist often has optimism that their model will generalize well to related environments, they are nevertheless faced with the possibility that the model may fail.

The present disclosure provides a framework to resolve this uncertainty in ML model performance, thereby allowing a roboticist to assess the generalization of behavior-cloned (BC) policies to new environments. For example, embodiments disclosed herein determine a confidence in a trained ML model's generalization to a new environment. For example, embodiments disclosed herein provide a confidence that a success rate of an ML model in executing a task in a new environment is representative of a true success rate. That is, for example, assume 10 trials that are performed by a trained ML model in a real-world new environment are successful 7 times (e.g., representing a 70% success rate). Embodiments disclosed herein can provide a measure of confidence that this success rate is representative of a true success rate of the trained model. In some case, measures of confidence of the ML models generalization to a plurality of new environments can be provided as a confidence interval on a success rate of the ML model in the new environments, from which the ML model's ability to generalization to new environments can be evaluated for deployment therein.

A confidence interval can be determined using various techniques. Examples include, but are not limited to, a binomial proportion confidence interval (e.g., a Wald or normal approximation interval, Clopper-Person interval, and the like), which provides a confidence interval for a probability of success calculated from the outcome of a series of success-failure experiments. In some illustrative examples provided herein, the confidence interval is provided as a lower confidence bound on a success rate.

Embodiments disclosed herein may access a performance metric, execute a number of policy rollouts in the new environment, record the performance of each rollout, and return a confidence interval for the distribution of performance in the new environment. To provide meaningful guarantees on the performance of a policy in a new environment, the policy may be executed directly in the new environment (e.g., actual action taken by an autonomous system controlled by the ML model in the new environment). Actual execution in a new environment may be unavoidable due to a BC assumption that dynamics or observation model of the environment may be unavailable to the ML model. In addition, cost of executing a trained policy in a new environment may be much less onerous than the cost of obtaining new training data for the new environment. This may be because executing a trained policy in a new environment can be automated and it may be difficult to collect new training data, especially if the task requires expert demonstrations. The embodiments disclosed herein may be designed to provably minimize a number of actual executions needed, thereby ensuring that costs for doing so are kept to a minimum.

If rollouts are independent and the environment is not time-varying, then each rollout can result in an i.i.d. sample from an unknown distribution of performance. Classical statistical methods can be used to place probabilistic worst-case bounds on the entire distribution of performance. Given this approach, embodiments disclosed herein can consider (i) how to formalize the notion of a worst-case bound on a distribution, and (ii) how to obtain bounds with user specified confidence level and tightness while using as few policy rollouts as possible.

In the case of formalizing the notion of a worst-case on a distribution, embodiments disclosed herein may use a cumulative distribution function (CDF) of a random variable that represents a performance metric. Given that higher performance is preferable to lower performance, this may mean that a CDF which is everywhere less than another CDF is preferable—this may be the typical notion of stochastic ordering for random variables. Thus, a partial ordering over CDFs arises where lower CDFs may be preferable to higher CDFs. From this partial ordering, an upper limit on a confidence interval can then serve as a worst-case distribution which is consistent with the observed data and the desired confidence and tightness.

Embodiments disclosed herein may consider one or more performance metrics for BC policies. In an illustrative example, embodiments disclosed herein may consider performance metrics in the form of (i) task success and (ii) total reward.

For task success metric, the distribution of performance may be a Bernoulli distribution, but with unknown success probability. In this case, an upper limit on a CDF of a Bernoulli distribution may be equivalent to a lower limit of a confidence interval on the probability of success (e.g., success rate). Thus, a lower limit of the confidence interval can be provided for the probability of success. This lower limit of a confidence interval can be compared with a baseline success rate which a user (e.g., a roboticist) wishes to surpass. For this limit, a user may specify a probability the limit holds, as well as an expected amount of looseness in the limit. Then, embodiments disclosed herein may aim to meet these specifications using a minimum number of policy rollouts. In some examples, the lower limit of the confidence interval may be provided as a lower confidence bound on the probability of success.

A total reward metric may measure the reward accumulated over the course of the trajectory (e.g., each rollout). In this case, the distribution of performance may be unknown and may be continuous, discrete, or mixed. In this case, an upper limit of the confidence interval can be provided on a CDF of the total reward distribution. By defining a partial order over total reward distributions, the upper limit can be compared with a baseline total reward CDF desired to outperform. This baseline can be considered a worst-case limit on each quantile of the total reward distribution. For this limit, a user may specify the probability the limit holds as well as the deviation of the bound away from the empirical CDF. Then, embodiments disclosed herein may meet these specifications using a minimum number of policy rollouts. In this example, the upper limit of the confidence interval can be computed, for example but not limited to, as a Dvoretzky-Kiefer-Wolfowitz inequality, which provides a bound on a worst case distance of an empirically determined distribution function from its associated population distribution function.

Embodiments disclosed herein make no assumptions on the definitions of task success or total reward. For instance, a reward can be time-varying within a trajectory so long as it is applied consistently across each trajectory. Additionally, no assumptions need to be made on the policy apart from it being stochastic. Furthermore, no assumptions need to be made on the underlying observation and transition of the new environments aside from them being stationary in time. These considerations may be made so as to apply the embodiments disclosed herein to realistic settings, such as robot learning from demonstrations where a mathematical model of the environment is not available.

From the above, the embodiments disclosed herein assess performance of BC policies generalized in new environments. If a policy generalizes to a new environment, as defined by a pre-specified performance metric threshold, the embodiments of the present disclosure can ascertain that the BC policy exceeds a minimum acceptable performance with high confidence. Thus, the present disclosure provides a framework for providing generalization guarantees for BC policies deployed in new environments. The present disclosure also provides for an application of lesser-known statistical techniques for bounding robot performance distributions. Further, the present disclosure provides solutions for computing a maximum expected shortage for binomial confidence intervals with an optimal tradeoff between coverage, tightness, and sample size.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

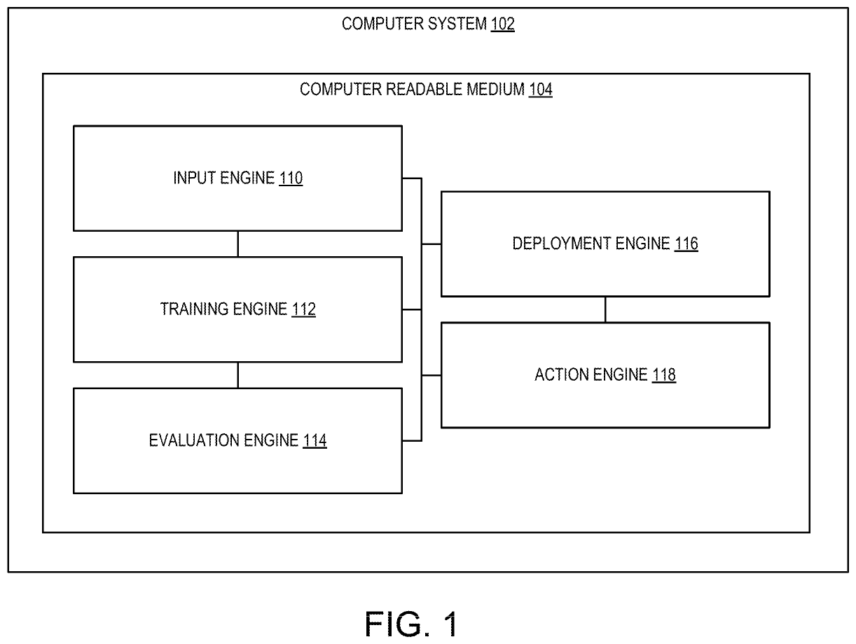

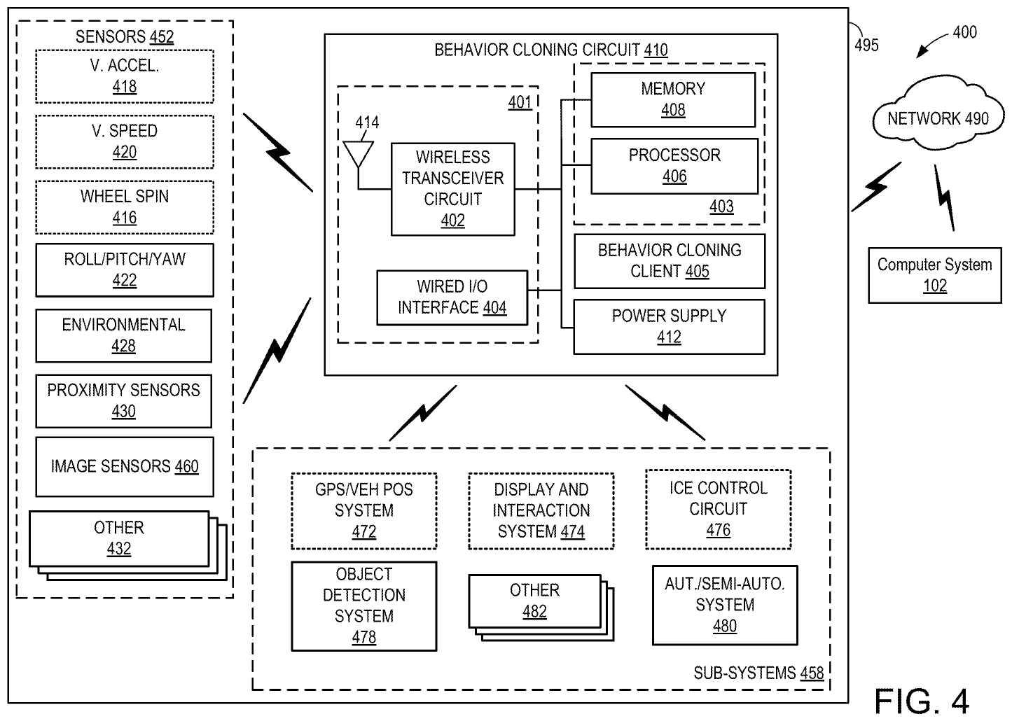

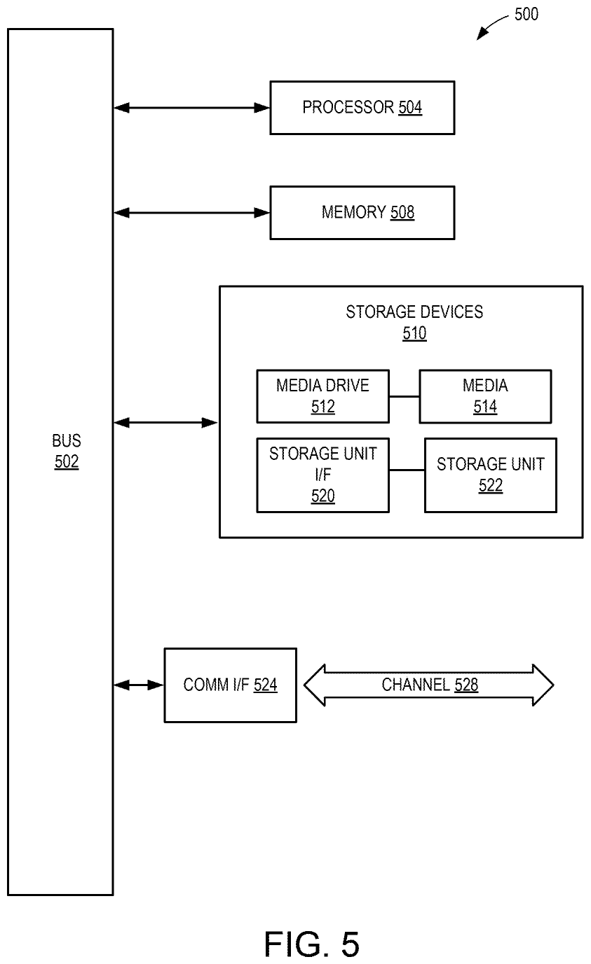

FIG. 1 is an illustrative representation of a computer system for implementing behavior cloning models, in accordance with one or more embodiments of the disclosure. Computer system 102 may comprise computer readable medium 104, input engine 110, training engine 112, evaluation engine 114, deployment engine 116, and action engine 118. Other components and engines (e.g., processor, memory, etc.) have been removed from the illustration of computer system 102 in order to focus on these features. Additional features of computer system 102 are provided with FIGS. 4-5.

Input engine 110 is configured to receive and/or store input training data. For example, input engine 110 may interact with a receiver configured to receive input data from one or more sensors of a robotic system. In an illustrative example, a robotic system may be implemented as a semi-autonomous or autonomous system, as described in connection with FIG. 4. While examples disclosed herein are described with reference to a robotic system, such as but not limited to, a robotic manipulator that is trained to manipulate objects within an environment, the present disclosure is not intended to be limited to robotic applications. Any semi-autonomous or autonomous system may be implemented as a system configured to interact with an environment under control by ML models. For example, the embodiments disclosed herein may be implemented in any of a number of different vehicles and vehicle types. For example, the systems and methods disclosed herein may be used with automobiles, trucks, motorcycles, recreational vehicles and other like on- or off-road vehicles.

In examples, input training data may be data collected during execution of a robotic system in one or more environments. The input training data may comprise states of the robotic system derived from sensor data collected by sensors and subsystems of while the robotic system executes tasks in the one or more environments. Referring to FIG. 4, sensor data may be collected by sensors 452 and/or sub-systems 458 of a robotic system 495.

Training engine 112 is configured to train an ML model using training data. As noted above, the training data may comprise the data collected by input engine 110 indicative of actual, real-world performance of a robotic system in one or more environments.

Training engine 112 may comprise an ML algorithm that is applied to the training data to generate an ML model. Training of the ML model comprises learning BC policies that are configured to imitate the training data by minimizing error or loss terms between the training data and actual, real-world states of the robotic system during operation. When deployed, the ML model is trained to control the robotic system to perform tasks according to the BC policies. The ML model may be trained to generalize beyond the training data to unseen inputs by reducing errors between the training and the real-world states. However, as described above, trained ML models can be brittle when deployed in new environments that are unseen in the training data. Thus, although the ML model is trained to generalize well to environments related to the training data, the ML model may nevertheless fail in new environments.

Accordingly, computer system 102 provides a framework to resolve this uncertainty in ML model performance by assessing the generalization of BC policies to new environments. The evaluation engine 114 can be configured to assess performance metrics based on executing a number of BC policy rollouts in one or more new environments. The deployment engine 116 may be configured to deploy a trained ML model on the robotic system, which executes the number of rollouts through action engine 118. Action engine 118 controls the robotic system according to the deployed BC policies in one or more new environments and collects sensor data from sensors and/or subsystems on the robotic system (e.g., sensors 452 and/or sub-systems 458). Input engine 110 can then collect the sensor data and supply the sensor data to the evaluation engine 114 and each executed rollout (referred to herein as a trial) can be evaluated for success or failure. The performance of the trained ML model in the new environments can then be assessed by evaluation engine 114.

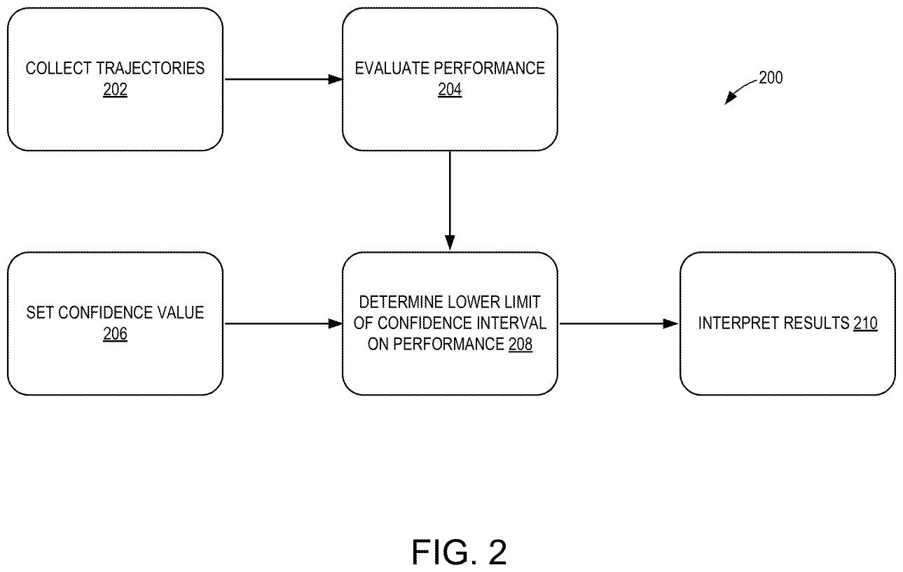

An example process flow of the assessment performed by evaluation engine 114 is provided in FIG. 2, which depicts an illustrative process flow 200. In the following description of process flow 200, n refers to a number of trials, p refers to a success probability, and k refers to a number of observed successes that are evaluated. The function ∥(x) denotes an indicator function which evaluates to one if x is true and zero otherwise. A floor function can be denoted as └x┘, which rounds an argument x down to the nearest integer. For a random sample of X₁, . . . , Xₙ, X₍ₖ₎ denotes the k-th order statistic (with X₍₁₎ denoting the minimum).

Operation 202 may be executed to collect a plurality of trajectories (e.g., samples X₁, . . . , Xₙ). For example, as described above, action engine 118 can be executed to cause a robotic system to perform a number n of trials in a new environment. The collected data from the performed trials can be provided as trajectories that define the actions and movements performed by the robotic system.

At operation 204, the performance of each trajectory can be evaluated. For example, each trial can be evaluated for success or failure and labeled accordingly. In one example, an operator may determine whether a trial was successful or not and assign a label to each trial. Operation 204 may determine a number k of observed successful trials.

At operation 206, a confidence value (α) can be set. The confidence value (α) may be representative of an acceptable probability that a derived confidence interval does not contain the true unknown success rate of the ML model in the new environment. Said another way, confidence value (α) may be representative of an acceptable lower limit or worst case that the derived confidence interval does not include the true success rate of the ML model. The confidence value (α) may correspond to a coverage (e.g., probability that a confidence interval or confidence region will include the true un known success rate), which can indirectly provide a confidence interval. In some examples, an operator may set the confidence value (α) to a desired lower limit of a confidence interval. In an example, the confidence value (α) may be set to a desired lower confidence bound.

At operation 208, a confidence interval on a performance (e.g., a true, but unknown success rate) can be determined with statistical guarantees. Operation 208 may determine a lower limit of the confidence interval that trades-off between coverage, tightness, and number of trials to achieve the confidence value (α). That is, given confidence value (α), operation 208 balances the coverage, tightness, and a number of trials needed to achieve the confidence value (α).

Operation 208 may determine a confidence interval, including the lower limit of the confidence interval, using any technique. For example, operation 208 may determine a confidence interval and corresponding lower limit using, not limited to, a binomial proportion confidence interval (e.g., a Wald or normal approximation interval, Clopper-Person interval, and the like), a Dvoretzky-Kiefer-Wolfowitz inequality, or the like. In some examples, operation 208 may determine the lower limit of the confidence interval as a lower confidence bound on success.

In a first example, performance of an ML model in a new environment can be measured based on binary success/failure. In this case, a performance of each trial can be represented as a Bernoulli random variable X, where X=1 denotes a success and X=0 denotes a failure. A probability of success p (e.g., actual success rate) of the ML model in the new environment is unknown. From the sample of n trials performed (e.g., operation 202) having outcomes X_{1:n}, a lower limit on the confidence interval p on an acceptable confidence (e.g., confidence value (α)) of a representative probability of success can be constructed. This lower limit on the confidence interval may represent a worst case acceptable probability of success (e.g., a lower confidence bound on acceptable success rate). The number of successes in the sampled outcomes follows a binomial distribution.

In an illustrative example in which operation 208 computes a lower limit on the confidence interval p as a lower confidence bound, operation 208 computes a probability ( [symbol] ) that the lower confidence bound p is less than or equal to the actual probability. This probability ( [symbol] ) or confidence in the lower confidence bound p can be determined by minimizing the following equation:

$$ℙ ( \underline{p} \leq p ) = 1 - α \qquad Eq . l$$

where the lower confidence bound p can be provided as:

$$\underline{p} := sup \{ p ∈ ( 0 , 1 ) \vert {F}_{p} ( t ) > 1 - α \} \qquad Eq . 2$$

where Fₚ(t) is the CDF of T and t is the realized quantity of T. T is the test statistic of the n trials provided as:

$$T = U + {\sum }_{i = 1}^{n} {X}_{i} \qquad Eq . 3$$

where U is a random number between zero and one (e.g., U˜ [symbol] [0,1]) and Xᵢ are i.i.d. samples (e.g., trials) from a Bernoulli distribution with unknown success probability p.

Operation 208 can also be executed to control a tightness of the lower limit of the confidence interval p relative to the actual unknown success probability p. That is, in the above example where operation 208 computes a lower confidence bound, Eqs. 1-3 can be used to compute the probability that the actual probability p is at least greater than the lower confidence bound p, the following can provide a measure of how close the lower confidence bound p is to the actual unknown success probability p. In an example, the notion of shortage (e.g., excess length) can be used to control the tightness, shown as:

$$shortage = max \{ p - \underline{p} , 0 \} \qquad Eq . 4$$

Since p may be random, it can be useful to consider expected shortage as:

$$E S ( p ) = {𝔼}_{p} [ shortage ] = {\int }_{0}^{p} {F}_{p} ( t * ( {p}_{0} ) ) d {p}_{0} \qquad Eq . 5$$

where t*(p₀) is a unique value that satisfies Fₚ(t*)=1−α, [symbol] (p≤p)= [symbol] (t≤t*(p₀) and t* serves as a threshold by which we decide a value of p₀ is covered by the lower confidence bound.

Expected shortage on its own may not be the most useful measure of tightness because it depends on p, which is unknown. Thus, some examples assess tightness via maximum expected shortage (MES) provided as:

$$MES = \begin{matrix}sup \\ p ∈ [ 0 , 1 ]\end{matrix} {𝔼}_{p} [ shortage ] \qquad Eq . 6$$

Thus, MES can be computed via global optimization. Equation 5 is a mixed-monotonic function, and Equation 4 can be efficiently solved using a branch-and-bound algorithm. Although the notion of MES may have appeared in the literature before, the inventors believe they are the first to solve for it as set forth herein.

While the above example is described with reference to computing a lower confidence bound, one skilled in the art would appreciate that the above methodologies can be extended to other techniques for computing the lower limit of a confidence interval, such as but not limited to, binomial proportion confidence intervals (e.g., a Wald or normal approximation interval, Clopper-Person interval, etc.) and the like, as known in the art.

Accordingly, for the case of the binary success metric, operation 208 can compute a lower limit on a confidence interval, which optimally trades-off between coverage provided as (1−α), tightness provided by Equation 6, and a number of samples (n). Thus, given a coverage and tightness specification (e.g., provided by an operator), operation 208 can compute the minimum number of policy rollouts needed to obtain a lower limit on a confidence interval which meets the specified coverage and tightness. A given set of coverage, tightness, and number of trials may be referred to herein as a confidence set. Thus, a confidence set can be optimally determined for a given ML model executed in a new environment and deployment considerations can be made based on the confidence set.

In an example, an operator may specify a desired coverage rate (e.g., 90%) by specifying a and a worst-case expected value for the tightness of the bound (e.g., 10%) by specifying MES. Then, operation 208 can pre-compute a minimum number n of trials (e.g., policy rollouts) to perform in the new environment to evaluate the policy's performance in the new environment. Alternatively, the worst-case expected value for the tightness could be pre-computed, given a prespecified budget for the number of policy rollouts and a desired coverage rate.

In a second example, performance of an ML model in a new environment can be measured based on continuous total reward valued task reward. This example may be applicable to cases in which a binary success/failure is not applicable to a given task, for example, where success may be easily represented by binary representation.

In this case, operation 208 can obtain an upper limit of the confidence interval (e.g., an upper confidence bound in some examples) of the CDF of a random variable. The CDF upper limit can be constructed in such a way that, given specified coverage rate (a) and tightness, a minimum number of samples can be determined to meet these specifications. In this case, the upper limit of the confidence interface on the CDF corresponds to a lower limit on a confidence interval on the probability of success (e.g., worst case acceptable probability). In the example of an upper confidence bound on the CDF, the upper confidence bound can be provided as:

$$ℙ ( F ( x ) \leq \overline{F} ( x ) ∀ x ) \geq 1 - α \qquad Eq . 7$$

where samples X_{1:n} form a unknown distribution with CDF F(x) and F̅(x) is:

$$\overline{F} ( x ) = {F}_{n} ( x ) + {ϵ}^{*} \qquad Eq . 8$$

where Fₙ(x) is an empirical CDF and ∈* is an offset term. The tightness in this case is based on the offset term ∈*, and thus can be controlled accordingly. The smaller the value of the offset term, the smaller the tightness. As such, tightness may not need to be computed as it is defined by the offset term.

While the above example is described with reference to computing an upper confidence bound, it will be appreciated that one skilled in the art would understand that the above example can be extended to other techniques for computing the upper limit of a confidence interval, such as but not limited to, Dvoretzky-Kiefer-Wolfowitz inequalities and the like, as known in the art.

Accordingly, for the case of the continuous total reward metric, operation 208 can compute an upper limit of the confidence interval on the CDF which optimally trades-off between coverage corresponding to a (e.g., set in operation 206), tightness provided by the offset term, and a number of samples (n). Thus, given a coverage and offset term specification (e.g., provided by an operator), operation 208 can compute a minimum number of policy rollouts needed to obtain an upper limit of the confidence interval of the CDF (e.g., lower confidence bound on the probability) which meets these specifications. Thus, a confidence set can be optimally determined for a given ML model executed in a new environment and deployment considerations can be made based on the confidence set.

In an example, similarly to the binary success/failure example, an operator may specify a desired coverage and tightness of the bound. Operation 208 uses this to compute a value for a minimum number of necessary policy rollouts in the new environment. Once the policy has been rolled out and the observations of task rewards have been made, an upper limit of the confidence interval for the (unknown) true CDF of the reward can be computed. The upper limit can be compared with a baseline total reward CDF desired to be outperformed. One can think of this baseline as a worst-case bound on every quantile of the total reward distribution.

Referring to FIG. 2, at operation 210 the results of operation 208 can be interpreted and certain actions taken based on the results. For example, operation 210 may compare the results from operation 208 with one or more thresholds. For example, the lower limit of the confidence interval computed at operation 208 can be compared to a threshold. For example, a lower limit threshold and/or tightness threshold may be specified by an operator. In one example, the ML model may be deployed on robotic systems in the new environments in which the lower limit of the confidence interval exceeds the threshold, because the operator has a threshold confidence in the ML model successfully performing the trained tasks according to lower limit of the confidence interval on the success rate. In another example, the ML model may be retrained when the performance metric is below a threshold, which may be the same or a different threshold value as the above. Retraining may include training the ML model on data obtained from the new environment. In yet another example, lower limit of the confidence intervals of multiple ML models for a given new environment may be computed by operation 208. These limit of the confidence intervals can be compared and the ML model having the highest performance metric (e.g., highest lower confidence bound and/or smallest tightness as specified by an operator) may be selected, from the multiple ML models, for deployment on robotic systems in the new environment.

As another example, operation 210 can identify the upper limit of the confidence interval for the (unknown) true CDF computed at operation 208 and compare this with a baseline total reward CDF desired to be outperformed. This can be used to ensure the trained model outperforms a desired performance.

In another example, operation 210 may select an ML model from multiple ML models by comparing success rates of the multiple ML models. Said another way, operation 210 may compare a lower limit of the confidence interval on the success rate of a first ML model with an upper limit of the confidence interval on a success rate of a second ML model. Operation 210 may select the first ML model based on the lower limit of the confidence interval being larger than the upper limit of the confidence interval of the second ML Model. For example, operation 210 may compute the lower limit of the confidence interval as a lower confidence bound on the success rate of the first ML model (p_{ML1}), as described above. Operation 210 may also compute an upper confidence bound on the success rate of the second ML model (p_{ML2}), for example, by subtracting the lower confidence bound on the failure rate of the second ML model from one (e.g., 1−p_{ML2}, where p_{ML2} is the lower confidence bound on the failure rate). The lower confidence bound on the failure rate can be computed in a manner similar to that described above for the lower confidence bound on the success rate, except for the computation uses a failure probability opposed to a success probability. In this case, a joint confidence value may be constrained as follows:

$$ℙ [ {p}_{M L 1} ∈ [ {\underline{p}}_{{}^{ML 2}} , 1 ] ∩ {p}_{M L 2} ∈ [ 0 , {\overline{p}}_{M L 2} ] ] \geq {α}_{Joint} \qquad Eq . 9$$

where confidence values for the first and second ML models are selected to ensure that the joint confidence value (α_{Joint}) is a desired value. In this example, α_{Joint} may be 0.95 and the confidence value for each ML model is set to 0.975 to ensure that α_{Joint} is 0.95. Then, if p̅_{ML2} is less than p̅_{ML1}, operation 210 can conclude that the first ML model outperforms the second ML Model and selects the first ML model for deployment on robotic systems in the new environment.

Similar approaches can be utilized for other means of computing a lower limit of the confidence interval as described above to compare a lower limit of the confidence interval of one ML model to an upper limit of the confidence interval of another ML model.

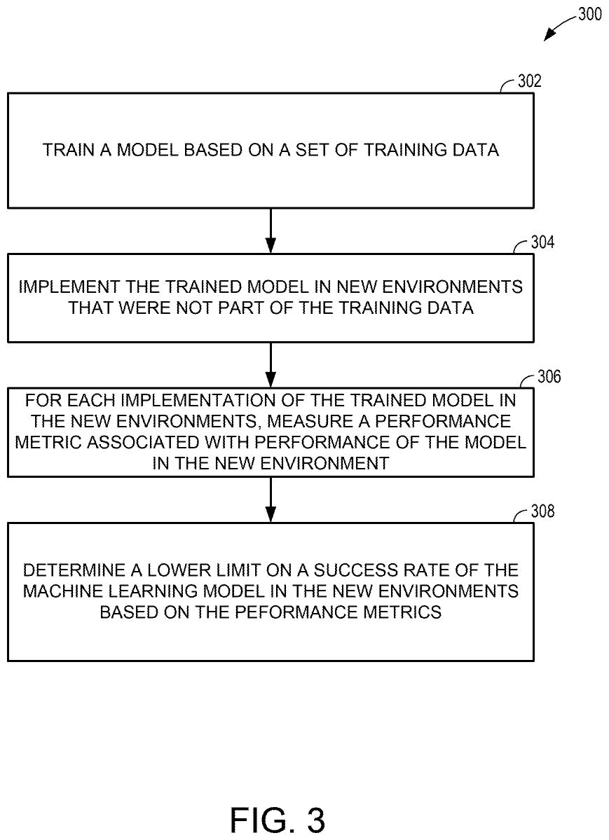

FIG. 3 provides operations that may be carried out in connection with computer implemented method 300, according to one or more embodiments of the present disclosure. For example, computer system 102 of FIG. 1 may implement the operations described herein.

At operation 302, a model can be trained on a set of training data. The training data may be obtained from one or more environments, for example, by sensors or subsystem of a robotic system. The training data may be applied to an ML algorithm to generate a trained ML model with BC policies that attempt to imitate the training data, as described above in connection with FIGS. 1 and 2.

At operation 304, the trained model can be implemented in one or more new environments that were part of the training data. For example, the trained model can be deployed on machines that execute a task a number of times (e.g., trials) within a new environment according to BC policies learned in the training. Sensor data from the machines may be collected, as described above in connection with FIGS. 1 and 2, for evaluating performance of each execution of the task.

At operation 306, for each implementation of the trained model in the one or more new environments, a performance metric, associated with the performance of the model in the new environment, can be measured. For example, as described above in connection with FIGS. 1 and 2, a performance metric can be measured as a binary success/failure or as a continuous total reward. In the case of a binary success/failure, each implementation can be labeled as a success or failure.

At operation 308, a lower limit of the confidence interval on a success rate of the machine learning model in the new environments can be determined for each of the one or more environments based on the performance metrics. Each lower limit of the confidence interval can be compared to a predetermined threshold and a determination can be made as to whether or not the lower limit of the confidence interval of the new environment exceeds the predetermined threshold. In one example, if a lower limit of the confidence interval is equal to or exceeds the threshold, the model may be deployed on machines with the new environments associated with the lower limit of the confidence interval. In another example, if a lower limit of the confidence interval is below the threshold, the model may not be deployed. In some cases, the model may be retrained.

In another example, lower limit of the confidence intervals for a plurality of models may be computed for a new environment for evaluating which model to deploy therein. For example, the model having the highest lower limit of the confidence interval may be deployed in favor of the other models. Highest lower limit of the confidence interval may refer to the highest lower limit of the confidence interval (or upper lower limit of the confidence interval on CDF for the continuous total reward implementation) or the smallest tightness.

FIG. 4 illustrates an example architecture for a behavior cloning system in accordance with one embodiment of the systems and methods described herein. Referring now to FIG. 4, in this example, behavior cloning system 400 includes a robotic system 495 that comprises a behavior cloning circuit 410 that can be installed on a robot, such as a robotic manipulator. While FIG. 4 is described as a robotic system, embodiments disclosed herein are not limited to robotic applications. For example, embodiments disclosed herein can be implemented on any autonomous or semi-autonomous system, such that robotic system 495 may instead represent a vehicle that comprises behavior cloning circuit 410 that can be installed thereon.

The robotic system 495 comprises a plurality of sensors 452 and a plurality of systems 458. Sensors 452 and systems 458 can communicate with behavior cloning circuit 410 via a wired or wireless communication interface. Although sensors 452 and systems 458 are depicted as communicating with behavior cloning circuit 410, they can also communicate with each other as well as with other vehicle systems. In some examples, behavior cloning circuit 410 can be implemented as an ECU or as part of an ECU such as, for example electronic control unit of a vehicle. In other embodiments, behavior cloning circuit 410 can be implemented independently of an ECU.

Behavior cloning circuit 410 in this example includes a communication circuit 401, a decision circuit 403 (including a processor 406 and memory 408 in this example) and a power supply 412. Components of behavior cloning circuit 410 are illustrated as communicating with each other via a data bus, although other communication in interfaces can be included. Behavior cloning circuit 410 in this example also includes behavior cloning client 405 that can be operated to connect to an edge server of a network 490 to contribute sensor data for training of ML models (e.g., as described above in connection with FIGS. 1 and 2). In another example, behavior cloning client 405 that can be operated to download trained ML models from network 490 for use by systems 458. The trained ML models may be deployed onto robotic system 495 as described above in connection with FIGS. 1 and 2.

Processor 406 can include one or more GPUs, CPUs, microprocessors, or any other suitable processing system. Processor 406 may include a single core or multicore processor. The memory 408 may include one or more various forms of memory or data storage (e.g., flash, RAM, etc.) that may be used to store instructions and variables for processor 406 as well as any other suitable information. Memory 408 can be made up of one or more modules of one or more different types of memory, and may be configured to store data and other information as well as operational instructions that may be used by the processor 406 to behavior cloning circuit 410.

Although the example of FIG. 4 is illustrated using processor and memory circuitry, as described below with reference to circuits disclosed herein, decision circuit 403 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a behavior cloning circuit 410.

Communication circuit 401 includes either or both a wireless transceiver circuit 402 with an associated antenna 414 and a wired I/O interface 404 with an associated hardwired data port (not illustrated). In embodiments where robotic system 496 is implemented as vehicle, communication circuit 401 can provide for vehicle-to-everything (V2X) and/or vehicle-to-vehicle (V2V) communications capabilities, allowing behavior cloning circuit 410 to communicate with edge devices, such as roadside unit/equipment (RSU/RSE), network cloud servers and cloud-based databases, and/or other vehicles via network 490. For example, V2X communication capabilities allows behavior cloning circuit 410 to communicate with edge/cloud servers, roadside infrastructure (e.g., such as roadside equipment/roadside unit, which may be a vehicle-to-infrastructure (V2I)-enabled street light or cameras, for example), etc. Behavior cloning circuit 410 may also communicate with other connected vehicles over vehicle-to-vehicle (V2V) communications.

As this example illustrates, communications with behavior cloning circuit 410 can include either or both wired and wireless communications circuits 401. Wireless transceiver circuit 402 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 414 is coupled to wireless transceiver circuit 402 and is used by wireless transceiver circuit 402 to transmit radio signals wirelessly to wireless equipment with which it is connected and to receive radio signals as well. These RF signals can include information of almost any sort that is sent or received by behavior cloning circuit 410 to/from other entities such as sensors 452 and systems 458.

Wired I/O interface 404 can include a transmitter and a receiver (not shown) for hardwired communications with other devices. For example, wired I/O interface 404 can provide a hardwired interface to other components, including sensors 452 and systems 458. Wired I/O interface 404 can communicate with other devices using Ethernet or any of a number of other wired communication protocols whether standardized, proprietary, open, point-to-point, networked or otherwise.

Power supply 412 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to robotic system supplied power, etc.), an energy harvester (e.g., solar cells, piezoelectric system, etc.), or it can include any other suitable power supply.

Sensors 452 can include additional sensors that may or may not otherwise be included on a standard robotic system with which the behavior cloning system 400 is implemented. In the illustrated example, sensors 452 include accelerometers such as a 4-axis accelerometer 422 to detect roll, pitch and yaw of the vehicle, environmental sensors 428 (e.g., to detect salinity or other environmental conditions), and proximity sensor 430 (e.g., sonar, radar, lidar or other vehicle proximity sensors). Additional sensors 432 can also be included as may be appropriate for a given implementation of behavior cloning system 400. In example in which robotic system 495 is implemented as a vehicle, sensors 452 may also include vehicle acceleration sensors 418, vehicle speed sensors 420, and wheelspin sensors 416 (e.g., one for each wheel).

System 400 may be equipped with one or more image sensors 460. These may include front facing image sensors, side facing image sensors, and/or rear facing image sensors. Image sensors may capture information which may be used in detecting not only conditions of the robotic system but also detecting conditions external to the robotic system as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 460 can be used to, for example, to detect objects in an environment surrounding a robotic system 495 comprising behavior cloning circuit 410. As another example, object detection and recognition techniques may be used to detect objects and environmental conditions. Additionally, sensors may estimate proximity between robotic system 495 and other objects in the surrounding environment. For instance, the image sensors 460 may include cameras that may be used with and/or integrated with other proximity sensors 430 such as LIDAR sensors or any other sensors capable of capturing a distance.

Systems 458, for example, systems and subsystems 158 described above with reference to the example of FIG. 1, can include any of a number of different components or subsystems used to control or monitor various aspects of the robotic system 495 and its performance. In this example, the systems 458 may include one or more of: object detection system 478 to perform image processing such as object recognition and detection on images from image sensors 460, proximity estimation, for example, from image sensors 460 and/or proximity sensors, etc. for use in other vehicle systems; and other vehicle systems 482 (e.g., autonomous or semi-autonomous driving systems 480, such as forward/rear collision detection and warning systems, autonomous or semi-autonomous control systems, and the like). In the case of a vehicle, systems 458 may also include a vehicle positioning system 472; engine control circuits 476 to control the operation of engine (e.g. internal combustion engine and/or electric motors); vehicle display and interaction system 474 (e.g., vehicle audio system for broadcasting notifications over one or more vehicle speakers), vehicle display system and/or the vehicle dashboard system); and Advanced Driver-Assistance Systems (ADAS).

Autonomous or semi-autonomous control systems 480 can be operatively connected to the various systems 458 and/or individual components thereof. For example, autonomous or semi-autonomous control systems 480 can send and/or receive information from the various systems 458 to control the movement, speed, maneuvering, heading, direction, etc. of the robotic system. The autonomous or semi-autonomous control systems 480 may control some or all of these systems 458 and, thus, may be semi- or fully autonomous.

Network 490 may be a conventional type of network, wired or wireless, and may have numerous different configurations including a star configuration, token ring configuration, or other configurations. Furthermore, the network 490 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 490 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 490 may include one or more IEEE 802.11 wireless networks.

In some embodiments, the network 490 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation, behavior cloning circuit 410 may receive sensor data from various sensors that represent states of the robotic system 495 over time. Communication circuit 401 can be used to transmit and receive information between behavior cloning circuit 410 and sensors 452, and behavior cloning circuit 410 and systems 458. Also, sensors 452 may communicate with systems 458 directly or indirectly (e.g., via communication circuit 401 or otherwise). The states of the robotic system 495 may be provided as time-series data, where each state comprises a time stamp of the point in time at which the state was detected by the sensors 452 and/or subsystems 458.

The states may be transmitted via communication circuit 401 to computer system 102 to contribute to training. As described above, computer system 102 collects input data for training an ML model and deploy the model to machines (e.g., robotic system 495) for performing trials in new environments. In an example, robotic system 495 may use communication circuit 401 to download a trained model from computer system 102 via network 490. The robotic system 495 may then implement the trained model in a new environment as a trial. Sensor data may be collected by sensors 452 and/or subsystems 458 and then communicated to computer system 102 via communication circuit 401. Computer system 102 may then assess the performance of the model in the new environment, as described above in connection with FIGS. 1 and 2.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up computer system 102 of FIG. 1. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. For example, operations of process flow 200 and/or method 300 may be stored as executable instructions. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 522, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
training a machine learning model based on a set of training data;
implementing the trained machine learning model a number of times in a new environment, wherein the new environment is not part of the training data;
for each implementation of the trained machine learning model in the new environment, measuring a performance metric associated with performance of the machine learning model in the new environment;
determining a confidence interval on a success rate of the machine learning model in the new environment based on the performance metric; and
deploying the machine learning model on machines in the new environment based on the confidence interval.

2. The method of claim 1, wherein the training data is based on implementing the trained machine learning model in one or more environments that are different from the new environment.

3. The method of claim 1, wherein implementing the trained machine learning model comprises:
deploying the trained machine learning model on a machine in the new environment.

4. The method of claim 1, wherein the performance metric comprises one of: (i) a binary success or failure of each implementation of the trained machine learning model in the new environment and (ii) a continuous total reward of each implementation of the trained machine learning model in the new environment.

5. The method of claim 1, further comprising: determining a confidence set based on the confidence interval, wherein the confidence set comprises a confidence value representative of an acceptable probability that the confidence interval does not contain a true unknown success rate and at least one of: a coverage of the confidence interval, a tightness of the confidence interval to the success rate, and a minimum number of times the trained machine learning model to implement the machine learning model.

6. The method of claim 1, wherein deploying the machine learning model on machines in the new environment based on the confidence interval comprises:
determining a lower limit of the confidence interval;
determining if the lower limit of the confidence interval exceeds a threshold; and
deploying the machine learning model on machines in the new environment when the lower limit of the confidence interval exceeds or is equal to the threshold.

7. The method of claim 6, further comprises:
retraining the machine learning model when the lower limit of the confidence interval is below the threshold.

8. The method of claim 1, further comprising:
determining a plurality of confidence intervals for the new environment based on implementing a plurality of machine learning models in the new environment;
determining an optimal confidence interval from the plurality of confidence interval; and
deploying, on machines in the new environment, a machine learning model of the plurality of machine learning models corresponding to the optimal confidence interval.

9. The method of claim 1, further comprising:
receiving an input of one or more of: (i) a confidence value representative of an acceptable lower limit of the confidence interval on a success rate of the machine learning model in the new environment and (ii) tightness of the lower limit of the confidence interval to the success rate; and
computing a minimum number of implementations of the of the trained machine learning model in the new environment based on the input and a cumulative distribution function of the performance metric, wherein the minimum number of implementations is a number of implementations needed to achieve the input based on the performance metric,
wherein the determined confidence interval comprises the input and the minimum number of implementations of the trained machine learning model in the new environment.

10. The method of claim 1, wherein the machines comprise vehicles.

11. A system comprising:
a memory configured to store instructions; and
at least one processor communicatively coupled to the memory and configured to execute the instructions to:
obtain a machine learning model trained on a set of training data;
implement the trained machine learning model a number of times in a new environment;
for each implementation of the trained machine learning model in the new environment, measure a performance metric associated with performance of the machine learning model in the new environment;
determine a confidence interval on a success rate of the machine learning model in the new environment based on the performance metric; and
deploy the machine learning model on machines in the new environment based on the confidence interval.

12. The system of claim 11, wherein the training data is based on implementing the trained machine learning model in one or more environments that are different from the new environment.

13. The system of claim 11, wherein implementing the trained machine learning model comprises:
deploying the trained machine learning model on a machine in the new environment.

14. The system of claim 11, wherein the performance metric comprises one of: (i) a binary success or failure of each implementation of the trained machine learning model in the new environment and (ii) a continuous total reward of each implementation of the trained machine learning model in the new environment.

15. The system of claim 11, further comprising: determining a confidence set based on the confidence interval, wherein the confidence set comprises a confidence value representative of an acceptable probability that the confidence interval does not contain a true unknown success rate and at least one of: a coverage of the confidence interval, a tightness of the confidence interval to the success rate, and a minimum number of times to implement the trained machine learning model.

16. The system of claim 11, wherein deploying the machine learning model on machines in the new environment based on the confidence interval comprises:
determining a lower limit of the confidence interval;
determining if the lower limit of the confidence interval exceeds a threshold; and
deploying the machine learning model on machines in the new environment when the lower limit of the confidence interval exceeds or is equal to the threshold.

17. The system of claim 16, wherein the at least one processor is further configured to execute the instructions to:
retrain the machine learning model when the lower limit of the confidence interval is below the threshold.

18. The system of claim 11, wherein the at least one processor is further configured to execute the instructions to:
determine a plurality of confidence intervals for the new environment based on implementing a plurality of machine learning models in the new environment;
determine an optimal confidence interval from the plurality of confidence intervals; and
deploy, on machines in the new environment, a machine learning model of the plurality of machine learning models corresponding to the optimal confidence interval.

19. The system of claim 11, wherein the at least one processor is further configured execute the instructions to:
receive an input of one or more of: (i) a confidence value representative of an acceptable lower limit of the confidence interval on a success rate of the machine learning model in the new environment and (ii) tightness of the lower limit of the confidence interval to the success rate; and
compute a minimum number of implementations of the of the trained machine learning model in the new environment based on the input and a cumulative distribution function of the performance metric, wherein the minimum number of implementations is a number of implementations needed to achieve the input based on the performance metric,
wherein the determined confidence interval comprises the input and the minimum number of implementations of the trained machine learning model in the new environment.

20. The system of claim 11, wherein the machines comprise vehicles.
